(19) United States
(12) Patent Application Publication
(10) Pub. No.: US 2007/0278711 A1
(43) Pub. Date: Dec. 6, 2007

(54) Method and apparatus for heat shrinking recycled plastic films

(76) Inventor: Emmanuel Levi, Chagrin Falls, OH (US)

Correspondence Address: Emmanuel Levi, 482 Greenhaven drive, Chagrin Falls, OH, 44022, US

(21) Appl. No.: 11/447,183

(22) Filed: Jun. 3, 2006

(51) Int. Cl. B29C 61/02

(52) U.S. Cl. 264/230; 264/338

(57) ABSTRACT

A method and apparatus that permits the shrinking of recycled multilayered plastic film by means of two molds which have been treated with a release agent and one of the molds being transparent or translucent that are flat or nearly flat that permits viewing of the sandwiched recycled shrinking plastic film. Also the remolding of a shrunken recycled multilayered plastic film by means of a mold. The recycled shrunk or remolded shrunk plastic film can be used as, but not limited to, ornamental or decorative or fastening. This invention can be fastened to different surfaces or materials.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates to the shrinking of recycled plastic films. More particularly, the present invention pertains to the method and apparatus for shrinking of recycled plastic film.

2. Prior Art

With reference to the web site publication “Potato Chip Bracelet” www.craftbits.com, an invention that pertains to the shrinking of recycled plastic films.

Furthermore, this publication discloses an apparatus and a method for the shrinking of recycled plastic films. The apparatus described in this publication consists of two molds which are neither transparent or translucent in which a recycled plastic film is placed in between, and with more specificity the molds create a space above the recycled shrinkable plastic film. This process has tendencies to create many wrinkles in the recycled plastic film. The recycled shrinkable material is then heated below its melting point. The process of shrinking the recycled plastic film must be visually inspected numerous times by lifting one of the molds to expose the shrinking recycled film until it has obtained a desired shape furthering the possibility of creating more wrinkles in the recycled plastic film.

Furthermore, what this publication discloses is the method to help remove the recycled shrunken film. This process is helped by a cooling method which entails pouring water on the hot mold. This process is not conducive for young individuals to do as it can cause possible injuries. Also, remolding the recycled shrunken film is not mentioned in prior art. The recycled shrunken film can be applied to various surfaces and materials by chemicals or mechanical fasteners. The process mentioned above is not visually engaging to individuals. Furthermore, this patent application submitted does not relate to the readily available commercial shrink art i.e. Shrinky Dinks, Polyshrink, Grafix Shrinkfilm, etc., because they do not use recycled plastic films.

3. Objects and Advantages

Several objects and advantages of the present invention are:
(a) to furnish a mold which is transparent or translucent that permits a visual assessment of the shrinking process that allows the individual or individuals to determine if the process is complete, and also permits the individual or individuals to stop the shrinking process at any given preferred size;
(b) to furnish a method which permits sandwiching of the recycled plastic film by using two molds which are flat or nearly flat, helping to minimize the wrinkles in the recycled plastic film;
(c) to furnish a mold which is transparent or translucent that permits the individual or individuals to be visually captivated by the shrinking process;
(d) to furnish a method in which the application of a release agent that is preventing the recycled plastic film from adhering to the mold surfaces, and therefore, permitting ease of removal;
(e) to furnish a method in which the shrunken recycled plastic film has the propensity of having less wrinkles, due to the method of sandwiching the recycled plastic film in between two molds that are flat or nearly flat, therefore, the back of the shrunken recycled plastic film has more flat surface area for a chemical fastener to make contact and adhere to the surface of an object;
(f) to furnish a method in which the shrunken recycled plastic film being remolded will retain the shape imparted by the mold.

Furthermore, the method and apparatus makes it more engaging for individuals to create a shrunken ornament or decoration to their specificities. From the use of this method and apparatus more advantages will become apparent from a consideration of the ensuing description and drawings.

When shrinking recycled multilayered material such as polypropylene-polyethylene plastic film, but not limited to this type of recycled plastic films. Molds are required to retain a desired shape. When the recycled plastic film is not sandwiched in between two molds while shrinking, the recycled plastic film will deform and curl up in unpredictable ways.

### SUMMARY OF THE INVENTION

Generally stated, the present invention comprises of two molds which are heat resistant, flat or nearly flat, with possibly one or two molds being transparent or translucent or neither and may be flexible, a release agent that is applied to the flat or nearly flat molds, and sandwiching of a shrinkable recycled plastic film in between two molds which are flat or nearly flat. This invention will shrink a recycled plastic film to the desired size when heat is applied to the molds and the recycled plastic film without going above the melting point of the recycled plastic film. The material for shrinking is well known and is commercially available recycled multilayered polypropylene-polyethylene plastic film, also known as packaging material for potato chips, candy, snacks, cookies, etc. For example, Frito-Lay snack bags, Dandee snack bags, Snyder snack bags, etc.

For a more complete understanding of the present invention, reference is made to the following description and accompanying drawings.

### BRIEF DESCRIPTION OF THE DRAWINGS

FIG. 1 is a perspective view of a recycled plastic film being sandwiched in between two molds that are flat or nearly flat and one being transparent.

FIG. 2 is a perspective view of a shrunken piece of recycled plastic film fastened to a mold.

FIG. 3 is a perspective view of a shrunken piece of recycled plastic film.

FIG. 4 is a perspective view of a shrunken piece of recycled plastic film fastened to a head covering.

FIG. 5 is a perspective view of a molded shrunken piece of recycled plastic film.

FIG. 6 is a perspective view of a molded shrunken piece of recycled plastic film fastened by means of a hook.

### DETAILED DESCRIPTION OF THE PREFERRED EMBODIMENT OF THE INVENTION

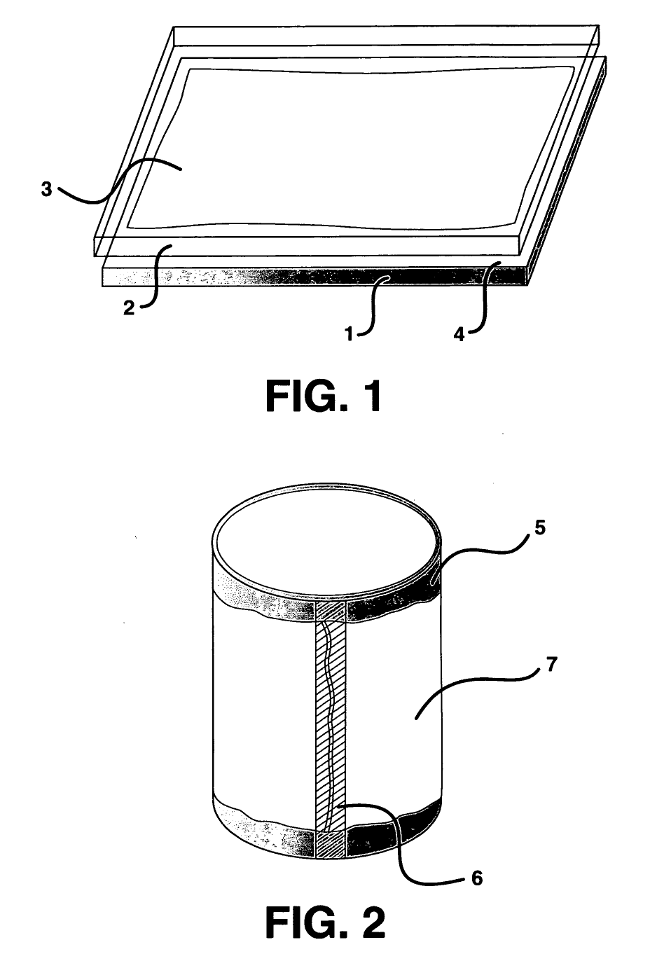

Now, and with more particularity, in reference to the drawing there is depicted therein in FIG. 1, a heat shrinkable recycled plastic film 3. What is shown in the drawing for this purpose, is a recycled multilayered polypropylene-polyethylene plastic film 3 which is sandwiched between molds 1 and 2 which are flat or nearly flat. For the purpose of FIG. 1, mold 1 is a piece of sheet metal and mold 2 is a transparent sheet of heat tempered glass. A release agent 4 is on the surfaces of the molds 1 and 2. For this purpose, a clear silicon fluid 4 has been used on the surfaces 1 and 2 which are in contact with the heat shrinkable recycled plastic film 3.

Now, and with more particularity, in reference to the drawing there is depicted therein in FIG. 2, in accordance with the present invention which is a shrunken recycled plastic film 7. For this purpose it is a shrunken recycled multilayered polypropylene-polyethylene plastic film 7 which is shown on the mold 5 which is heat resistant, for this purpose is a metallic cylindrical object 5. A fastener 6 is shown and may be of chemical or mechanical nature for this purpose, a well known and commercially available means is used, which is a piece of masking tape 6.

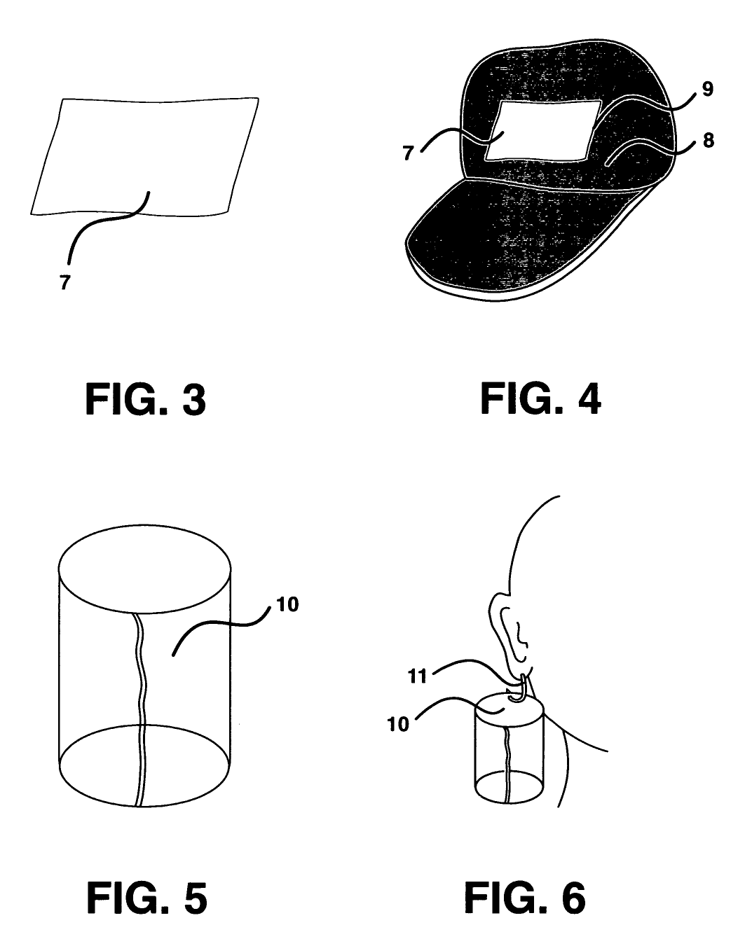

Now, and with more particularity, in reference to the drawing there is depicted therein in FIG. 3, a heat shrunken recycled plastic film 7 for this purpose, is a shrunken recycled multilayered polypropylene-polyethylene plastic film 7.

Now, and with more particularity, in reference to the drawing there is depicted therein in FIG. 4, a heat shrunken recycled plastic film 7 for this purpose, is a shrunken recycled multilayered polypropylene-polyethylene plastic film 7 which is shown on a head covering 8 which for this purpose is a cap 8, a chemical fastener 9 which for this purpose is glue 9 is shown on a cap 8.

Now, and with more particularity, in reference to the drawing there is depicted therein in FIG. 5, a heat shrunken molded recycled plastic film 10 for this purpose, is a shrunken molded recycled multilayered polypropylene-polyethylene plastic film 10.

Now, and with more particularity, in reference to the drawing there is depicted therein in FIG. 6, a heat shrunken molded recycled plastic film 10 for this purpose, is a shrunken molded recycled multilayered polypropylene-polyethylene plastic film 10. The shrunken molded recycled plastic film 10 is shown hanging by means of a hook 11, for this purpose an earring 11.

### Operation—FIGS. 1, 2, 3, 4, 5, 6

The Manner in Using the Method and the Apparatus:

Now, and with more particularity, in reference to the drawing there is depicted therein in FIG. 1 a heat shrinkable recycled plastic film 3. What is shown in the drawing for this purpose, is a recycled multilayered polypropylene-polyethylene film 3, which is sandwiched between molds 1 and 2 which are flat or nearly flat. For the purpose of FIG. 1 mold 1 is a piece of sheet metal and mold 2 is a transparent sheet of heat tempered glass. A release agent 4 has been applied to the surfaces of the molds 1 and 2. For this purpose, a clear silicon fluid 4, has been used on the surfaces 1 and 2 which are in contact with the heat shrinkable recycled plastic film 3. Thereafter, a heat shrinkable recycled plastic film 3 is shrunk by the application of heat to the entire assembly in FIG. 1 numbered 1, 2, 3, and 4, the recycled plastic film 3 will not be heated above its melting point. A cooling period of entire assembly in FIG. 1 numbered 1, 2, 3, and 4. When entire assembly 1, 2, 3, and 4 reaches room temperature you may proceed to next step, which is to expose the shrunken recycled plastic film 7 by removing mold 2. Then proceed by removing the shrunken plastic film 7 from the surface of mold 1. If remolding the shrunken recycled plastic film 7, do not remove release agent residue 4. If fastening shrunken recycled plastic film 7 then proceed to remove release agent residue 4 from shrunken recycled plastic film 7 by means of a rag with soapy solution. Allow the shrunken recycled plastic film 7 to dry. At the outset, it should be noted that a heat shrunken recycled plastic film 7 can be used as an ornamental or decorative object that can be fastened to various material, i.e. clothing, fixtures, accessories, walls, doors, containers, etc. The present invention is not limited to an ornamental or decorative object and to fastening.

In any event it is to be understood that in practicing the present invention and what is critical hereto is that a heat shrinkable recycled plastic film 3, when molded and heated not above the melting point, the shrunken recycled plastic film 3 will not resume its original shape.

Now, and with more particularity, in reference to the drawing there is depicted therein in FIG. 2, the heat shrunken recycled plastic film 7 is fastened to the mold 5, which is heat resistant, for this purpose is a metallic cylindrical object 5. A fastener may be of chemical or mechanical nature for this purpose, a well known and commercially available means is used, which is a piece of masking tape 6. A release agent may be applied to the mold surface. Thereafter, a shrunken recycled plastic film is molded by the application of heat to the entire assembly in FIG. 2, numbered 5, 6, and 7. A cooling period of entire assembly in FIG. 2, numbered 5, 7, and 10 (7 now becomes 10 because it is molded). At the outset, it should be noted that a heat shrunken molded recycled plastic film 10 can be used as an ornamental or decorative object that can be fastened to various material, i.e. clothing, fixtures, accessories, walls, doors, containers, etc. The present invention is not limited to an ornamental or decorative object and to fastening.

Now, and with more particularity, in reference to the drawing there is depicted therein in FIG. 3, a heat shrunken recycled plastic film 7. What is used for this purpose is a shrunken recycled multilayered polypropylene-polyethylene plastic film 7. The shrunken recycled plastic film 7 is not fastened to any surface or article. At the outset, it should be noted that a heat shrunken recycled plastic film 7 can be used as, but not limited to, an ornamental or decorative object.

Now, and with more particularity, in reference to the drawing there is depicted therein in FIG. 4, a heat shrunken recycled plastic film 7 for this purpose, is a shrunken recycled multilayered polypropylene-polyethylene plastic film 7. The shrunken recycled plastic film 7 is fastened by means of a chemical fastener 9, for this purpose is glue 9 is applied to a head covering 8 for this purpose is a cap 8. At the outset, it should be noted that a heat shrunken recycled plastic film 7 can be used as, but not limited to, an ornamental or decorative object that can be fastened to various material, i.e. clothing, fixtures, accessories, walls, doors, containers, etc.

Now, and with more particularity, in reference to the drawing there is depicted therein in FIG. 5, a heat shrunken molded recycled plastic film 10, for this purpose is a shrunken molded recycled multilayered polypropylene-polyethylene plastic film 10. The shrunken molded recycled plastic film 10 is not fastened to any surface or article. At the outset, it should be noted that a heat shrunken molded recycled plastic film 10 can be used as, but not limited to, an ornamental or decorative object.

Now, and with more particularity, in reference to the drawing there is depicted therein in FIG. 6, a heat shrunken molded recycled plastic film 10 for this purpose, is a shrunken molded recycled multilayered polypropylene-polyethylene plastic film 10, but can be of many other types in accordance with the present invention. The shrunken molded recycled plastic film 10 is fastened by the means of a hook 11, for this purpose is an earring 11. It should be noted that a heat shrunken molded recycled plastic film 10 can be fastened with a chemical fastener, for this purpose remove the release agent residue 4 by means of a rag with soapy solution. At the outset, the shrunken molded recycled plastic film 10 can be used as, but not limited to, an ornamental or decorative object that can be fastened to various material, i.e. clothing, fixtures, accessories, walls, doors, containers, etc.

The actual method for heat shrinking is well known to the skilled artisan, and is described in the aforementioned prior art. The disclosures of the above-noted prior art being hereby incorporated by reference. It is to be appreciated from the preceding that has been described herein, an apparatus for shrinking a recycled heat shrinkable material, and also a novel recycled heat shrinkable material that can be used as ornamental or decorative material, and can be fastened to various material, i.e. clothing, fixtures, accessories, walls, doors, containers, etc.

Although the description above contains many specificities, these should not be construed as limiting the scope of the invention, but as merely providing illustrations of some of the presently preferred embodiments of this invention. For example, the molds can have other shapes, such as circular, oval, trapezoidal, triangular, three dimensional molds, etc. It is also noted that recycled heat shrinkable plastic film can have a different composition than the preferred embodiment of this invention. For example, recycled plastic films: polyethylene, polyofin, multilayered, singled layered, etc. The method of fastening the recycled shrunken material can have a different means of fastening than the preferred embodiment of this invention. For example, with nails, paper clips, staples, stitching, epoxy, lamination, etc.

Thus the scope of the invention should be determined by the appended claims and their legal equivalents, and not by the examples given.

What is claimed is:

1. A method for shrinking recycled plastic films, which comprises:
selecting a heat shrinkable recycled plastic film, which can retain a shape to which it is shrunk,
selecting two molds which are heat resistant flat or nearly flat articles with one or two being transparent or translucent or neither and may be flexible,
applying a release agent to the molds surfaces,
sandwiching the shrinkable material in between the molds,
shrinking the material by applying heat to the molds and material,
the method of claim 1 which further comprises:
shrinking the material at a temperature below the melting point,
a cooling period of the shrunken material and the molds,
removing one or both of the molds to expose the shrunken material,
removing the shrunken material from the molds.

2. The method of shrinking recycled plastic films which can be used, wherein it is fastened to surfaces or articles:
selecting a heat shrinkable recycled plastic film which can retain a shape to which it is shrunk,
selecting two molds which are heat resistant flat or nearly flat articles with possibly one or two being transparent or translucent or neither and may be flexible,
applying a release agent to the molds,
sandwiching the shrinkable material in between two molds,
shrinking the material by applying heat to the molds and material,
the method of claim 2 which further comprises:
shrinking the material at a temperature below the melting point,
a cooling period of the shrunken material and the molds,
removing one or both of the molds to expose the shrunken material,
removing the shrunken material from the molds,
removing the release agent residue from the shrunken material,
applying shrunken material to a surface or article by means of a mechanical or chemical fastener.

3. A method using shrunken recycled plastic films and molding the shrunken material:
selecting a heat shrinkable recycled plastic films which can retain the shape to which it is shrunk,
selecting two molds which are heat resistant flat or nearly flat articles with possibly one or two being transparent or translucent or neither and may be flexible,
applying a release agent to the molds,
sandwiching the shrinkable material in between two molds,
shrinking the material by applying heat to the molds and material,
the method of claim 3 which further comprises:
shrinking the material at a temperature below the melting point,
a cooling period of the shrunken material and the molds,
removing one or both of the molds to expose the shrunken material,
removing shrunken material from the molds,
the method of claims 3 which further comprises:
applying shrunken material to a mold by means of a mechanical or chemical fastener,
reheating shrunken material and the mold below its melting point,
a cooling period of the shrunken molded material and mold,
removing a shrunken molded material from mold.

4. A method using shrunken recycled plastic films and molding the shrunken material wherein it is fastened to surfaces or articles:
selecting a heat shrinkable recycled plastic films, which can retain the shape to which it is shrunk,
selecting two molds which are heat resistant flat articles with possibly one or two being transparent or translucent or neither and may be flexible,
applying a release agent to the molds,
sandwiching a shrinkable material in between two molds,
shrinking the material by applying heat to the molds,
The method of claim 4 which further comprises:
shrinking the material at a temperature below the melting point,
a cooling period of the shrunken material and the molds,
removing one or both of the molds to expose the shrunken material,
removing the shrunken material from the molds,
the method of claim 4 which further comprises:
applying shrunken material to a mold by means of a mechanical or chemical fastener,
reheating shrunken material and mold below its melting point,
a cooling period of the shrunken molded material and the mold,
removing a shrunken molded material from mold,
removing release agent residue,
applying shrunken molded material to a surface or article by mechanical or chemical fasteners.
